(19) United States
(12) Patent Application Publication
(10) Pub. No.: US 2025/0373040 A1
(43) Pub. Date: Dec. 4, 2025

(54) BATTERY ELECTRIC SYSTEM WITH REFERENCE ELECTRODE AND MEASUREMENT IMPEDANCE COMPENSATION CIRCUITRY

(71) Applicant: GM GLOBAL TECHNOLOGY OPERATIONS LLC, Detroit, MI (US)

(72) Inventors: Brian J. Koch, Berkley, MI (US); Anne Zhang, Troy, MI (US); Jing Gao, Rochester, MI (US); Christine Labaza, Rochester, MI (US)

(73) Assignee: GM GLOBAL TECHNOLOGY OPERATIONS LLC, Detroit, MI (US)

(21) Appl. No.: 18/731,783

(22) Filed: Jun. 3, 2024

(51) Int. Cl. H02J 7/00

(52) U.S. Cl. CPC H02J 7/0048; H02J 7/0016; H02J 7/0019

(57) ABSTRACT

A battery electric system, e.g., of a vehicle, includes a battery cell, reference electrode, voltage sensing circuit, compensation circuit, and battery controller. The sensing circuit measures a cell voltage of the battery cell as a measured battery voltage, and outputs a digital voltage signal indicative of the battery voltage. The compensation circuit includes a capacitor and first and second switches. In accordance with a method, the first switch closes to connect the voltage source to the capacitor for charging thereof, with the capacitor connected in parallel with the sensing circuit. The second switch closes out-of-phase with the first switch to connect the compensation circuit to the sensing circuit. The controller outputs switching control signals to control respective duty cycles of the switches when measuring the cell voltage, and thereafter uses the digital voltage signal to perform a battery management action.

### INTRODUCTION

Electrochemical battery cells are used as direct current (DC) energy storage devices in a wide variety of applications, including but not limited to battery packs for energizing electric motors of vehicles, consumer products, and other mobile or stationary systems.

Hybrid electric and battery electric vehicles in particular employ a high-energy rechargeable battery pack to power one or more electric traction motors and other high-voltage power electronic components. Constituent battery cells of the battery pack include positive and negative electrodes forming a respective cathode and anode, along with an electrolyte material and a separator. A stack of the battery cells are electrically connected to a load, such as the aforementioned electric traction motor(s).

Lithium-ion batteries, which are commonly used in battery electric systems, operate by reversibly passing lithium ions between the anode and cathode via the electrolyte during a battery charging mode. When discharging the battery pack during a propulsion mode or another discharging mode, the lithium ions pass in the opposite direction, i.e., from the anode to the cathode. A state of charge of the battery pack may be estimated during operation of the battery electric system using a battery management system (battery controller). The battery controller may communicate with cell sense circuitry to determine a voltage difference between the cathode and anode. However, the measured voltage tends to change in a dynamic manner when the battery pack is actively charging or discharging. For this reason, battery voltages are often determined by measuring cathode or anode voltages with respect to a reference electrode that is not otherwise involved in energy storage or discharge processes. The reference electrode is therefore used as a reference point against which the measured potentials of the cathode and anode are compared.

### SUMMARY

Disclosed herein are battery electric systems having one or more battery cells and reference electrodes, for instance within a traction battery pack of a vehicle, and an associated method for determining and compensating for effects of polarization of the reference electrode. Electrode polarization may arise due to shifts in the reference electrode's electric potential. Factors such as aging, degradation, electrolyte impurities, and temperature swing effects tend to exacerbate the pernicious effects of polarization. Among other potential problems, polarization of a reference electrode reduces measurement accuracy when using the reference electrode for determining cell voltages. The solutions set forth herein therefore seek to improve upon available accuracy of battery voltage measurements. In turn, the present teachings optimize various battery management processes, such as but not limited to estimation or calculation of battery state of charge, state of health, remaining energy capacity, charge/discharge parameter control, and other useful quantities.

In particular, a battery electric system in accordance with an aspect of the disclosure includes a battery cell, e.g., a cell stack or string of cells having a lithium-ion or lithium metal construction), a reference electrode (e.g., a porous electrode), and a voltage sensing circuit (“sense circuit”). The sense circuit is operable for measuring a cell voltage of the battery cell as a measured voltage, and for outputting a digital voltage signal indicative of the measured voltage. The battery electric system also includes a compensation circuit and a battery controller. The compensation circuit includes a voltage source, an isolation capacitor connected in parallel with the sense circuit, and first and second switches.

The first switch, which is positioned between the voltage source and the sense circuit, closes in response to a first switching control signal from the battery controller. This control action connects the voltage source to the isolation capacitor. The second switch is connected between the compensation circuit and the sense circuit. The second switch in this particular implementation closes in response to a second switching control signal from the battery controller, which action connects the reference electrode and the compensation circuit to the sense circuit when performing a voltage measurement. The battery controller is in communication with the first and second switches. To measure the cell voltage, the battery controller outputs the first and second switching control signals and thereafter uses the digital voltage signal (measured voltage) to perform one or more battery management actions.

In one or more embodiments, the battery controller is programmed to control a closing and opening sequence of the first and second switches to match a reference voltage between the reference electrode and a working electrode of the battery cell at a previous time step when recharging the isolation capacitor.

The sense circuit may optionally include an analog-to-digital converter. In such an embodiment, the analog-to-digital converter may include a buffer amplifier having a parasitic bias current. The battery controller is thus configured to control operation of the compensation circuit to minimize a voltage drop across the reference electrode due to the parasitic bias current.

The battery controller in one or more implementations may control the operation of the compensation circuit such that a current draw of the reference electrode is characterized by an absence of frequencies below a respective duty cycle frequency of the first switch and the second switch. The battery controller may also be configured to estimate a state of charge (SOC) of the battery cell as the battery management action, and to adjust a charging or discharging parameter based on the SOC of the battery cell.

A vehicle is also disclosed herein. In a non-limiting construction, the vehicle includes road wheels connected to the vehicle body, an electric traction motor connected to one or more of the road wheels, and a battery pack connected to the electric traction motor. The battery pack is configured to energize the electric traction motor to power the one of more of the road wheels, and includes a reference electrode, a voltage sensing circuit (“sense circuit”), a compensation circuit, and a battery controller. The sense circuit is operable for measuring a cell voltage of a battery cell of the battery pack as a measured battery voltage, and for outputting a digital voltage signal that is indicative of the measured battery voltage. The compensation circuit is connectable to the voltage sensing circuit.

A possible construction of the compensation circuit includes a voltage source, an isolation capacitor that is connected in parallel with the sense circuit, and a first switch positioned between the voltage source and the isolation capacitor. The first switch is configured to close in response to a first switching control signal to thereby connect the voltage source to the isolation capacitor. The compensation circuit also includes a second switch that is connected between the compensation circuit and the sense circuit. The second switch is configured to close out-of-phase with the first switch in response to a second switching control signal. Closing the second switch connects the reference electrode and the compensation circuit to the sense circuit. The battery controller noted above is in communication with the first and second switches, and is operable to output the first and second switching control signals to control respective duty cycles of the first and second switches. The battery controller also measures the cell voltage via the reference electrode and sense circuit, and thereafter performs a battery management action using the digital voltage signal.

In addition to the above-summarized system implementations, a method is also disclosed for use with a battery electric system having a battery cell. The method in accordance with one or more implementations includes closing a first switch, via a battery controller, to connect a voltage source of a compensation circuit to an isolation capacitor. The isolation capacitor is connected in parallel with a voltage sensing circuit. The method further includes charging the isolation capacitor using the voltage source, opening the first switch via the battery controller after charging the isolation capacitor, and then closing a second switch after opening the first switch to thereby connect a reference electrode and the compensation circuit to a voltage sensing circuit (“sense circuit”).

The method in this embodiment also includes measuring a cell voltage of the battery cell using the reference electrode via the sense circuit, and then outputting a digital voltage signal to the battery controller via the sense circuit. The digital voltage signal is indicative of the measured cell voltage. Thereafter, the method includes performing a battery management action of the battery cell via the battery controller in response to the digital voltage signal.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 illustrates a representative battery electric system having a battery pack equipped with measurement and compensation circuitry constructed in accordance with the disclosure.

FIG. 2 is an equivalent circuit diagram of a representative embodiment of a compensation circuit usable with the battery electric system shown in FIG. 1.

FIG. 2A is an equivalent circuit diagram illustrating a portion of the representative compensation circuit of FIG. 2 showing parasitic voltages and currents compensated for by the technical solutions described herein.

FIG. 3 illustrates exemplary duty cycles of first and second switches of the compensation circuit depicted in FIG. 2.

FIG. 4 is a flow chart describing an embodiment of a method for compensating for high impedance in a battery measurement circuit in accordance with an aspect of the disclosure.

The appended drawings are not necessarily to scale, and may present a simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments may be arranged in a variety of configurations. Thus, the following detailed description is not intended to limit the scope of the disclosure as claimed, but is merely representative of possible embodiments thereof. In addition, while numerous specific details are set forth in the following description to provide a thorough understanding of various representative embodiments, some embodiments may be capable of being practiced without some of the disclosed details. Moreover, in order to improve clarity, certain technical material understood in the related art has not been described in detail. Furthermore, the disclosure as illustrated and described herein may be practiced in the absence of an element that is not specifically disclosed herein.

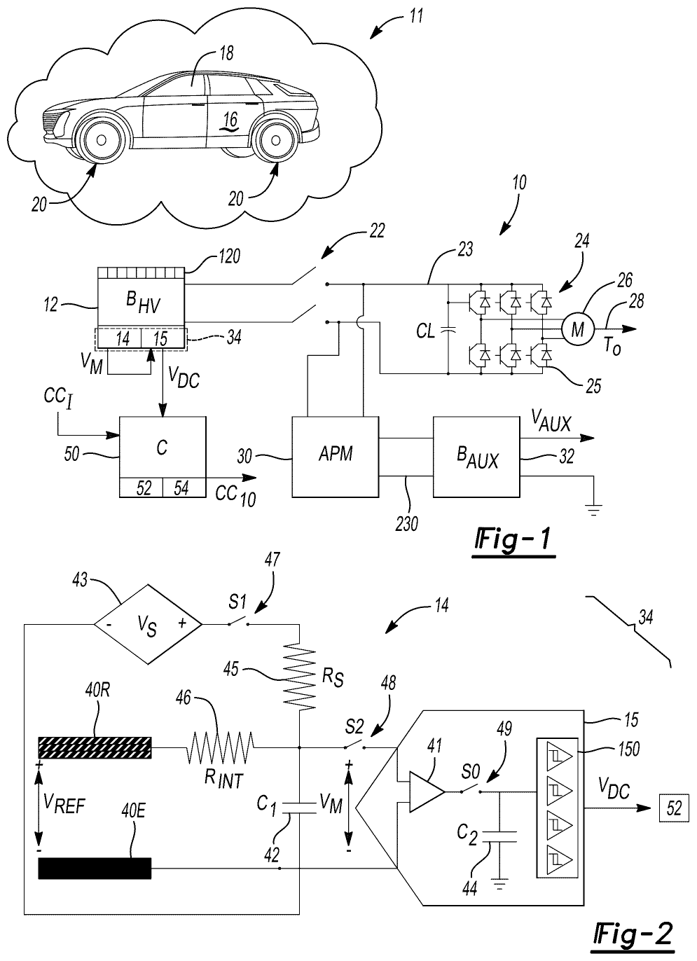

Referring now to the drawings, wherein like reference numbers refer to like features throughout the several views, FIG. 1 illustrates a battery electric system 10 having a rechargeable battery pack (B_{HV}) 12. The battery pack 12 is equipped with a cell measurement and compensation (MC) circuit 34 having a compensation circuit 14 and a voltage sensing circuit (“sense circuit”) 15, the latter of which is operable for periodically or continuously measuring battery voltage levels as measured battery voltages (V_{M}), and for outputting a digital voltage signal (V_{DC}) indicative of the measured battery voltage (V_{M}). For instance, the measured battery voltage(s) (V_{M}) may include individual cell voltages of a plurality of electrochemical battery cells 120, e.g., lithium-ion or lithium metal battery cells 120. The sense circuit 15 in particular, especially when constructed to facilitate mass production and integration into a fleet of vehicles 11 or other mobile or stationary hosts for the battery electric system 10, may tend to draw a large input bias current.

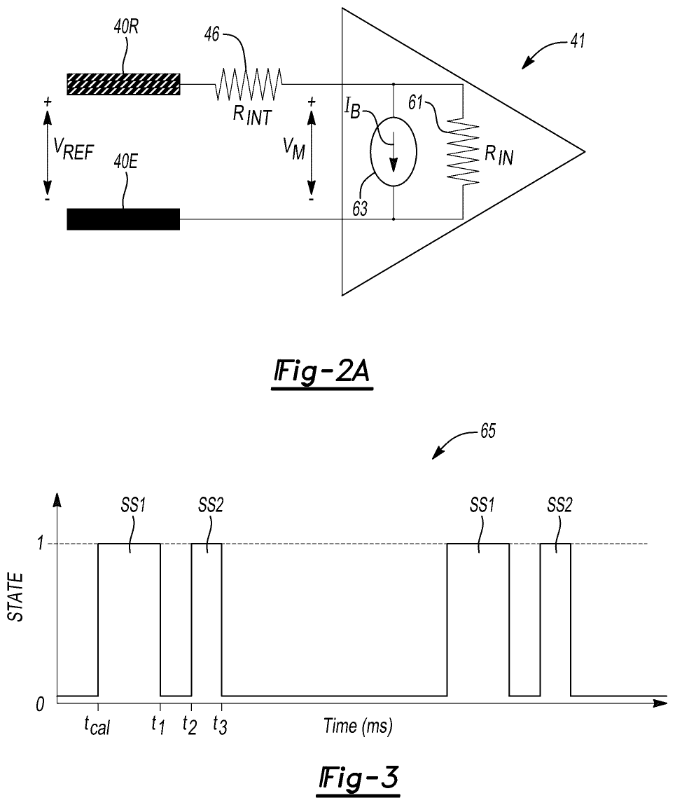

Referring briefly to FIGS. 2 and 2A, the battery pack 12 includes a reference electrode 40R of a type generally summarized above. Due to polarization effects, the reference electrode 40R acts as a high impendence element to the downstream sense circuit 15. As a result, a large voltage drop may occur across the sense circuit 15 during voltage measurements, which in turn reduces overall measurement accuracy. Electric potential of a working electrode 40E of the battery pack 12, e.g., a cathode or an anode of one of the battery cells 120 of FIG. 1, may be determined during operation of the battery electric system 10 of FIG. 1 with respect to the reference electrode 40R. The reference voltage (V_{REF}) is thereafter used as (or to determine) the measured voltage (V_{M}) of FIG. 1.

In one or more embodiments, the reference electrode 40R may be constructed as a porous electrode, for instance a porous lithium metal. As appreciated by those skilled in the art, porosity level of a porous electrode increases the surface area of the reference electrode 40R relative to non-porous alternatives, and thus its energy and power density.

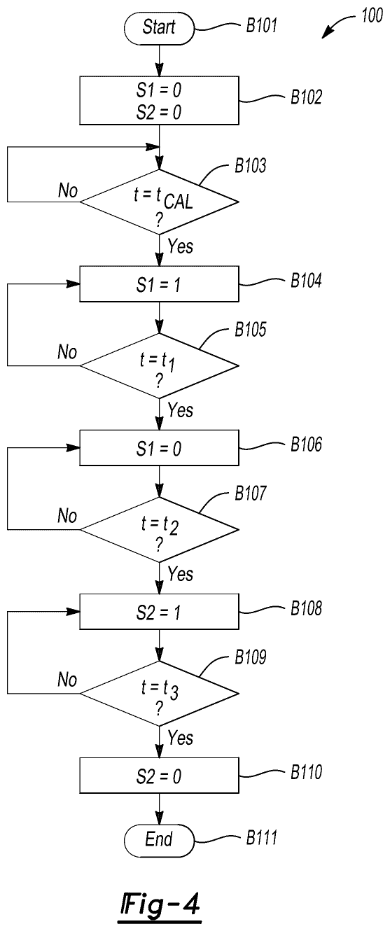

Referring once again to FIG. 1, measurement accuracy may be adversely affected by polarization of the reference electrode 40R of FIGS. 2 and 2A. To address potential problems associated with polarization, the battery electric system 10 is equipped with the compensation circuit 14, a non-limiting example of which is described below with particular reference to FIGS. 2 and 2A. Operation of the compensation circuit 14 is further explained with reference to FIGS. 3 and 4. The compensation circuit 14 as contemplated herein receives and processes the measured voltages (V_{M}) for one of the battery cells 120, or for the battery pack 12 as a whole. The sense circuit 15 acts on the measured voltage (V_{M}), for instance acting as an analog-to-digital converter in some embodiments. The sense circuit 15 also outputs the digital voltage signal (V_{DC}) to a battery controller (C) 50, for instance a battery management system of the representative vehicle 11 in a non-limiting embodiment.

The battery electric system 10 of FIG. 1 in one or more non-limiting embodiments may be used as a part of a vehicle 11, e.g., a motor vehicle as shown. In such an implementation, the vehicle 11 may include a vehicle body 16 defining a vehicle interior 18. While the vehicle 11 is described herein as a non-limiting host system for implementation of the present teachings, those skilled in the art will appreciate that the battery electric system 10 may be used in a wide range of mobile and stationary systems, including but not limited to consumer products, electrified powertrain systems of aircraft, marine vessels, railed vehicles, farm equipment, transport equipment, and other land, sea, or airborne mobile platforms, and powerplants, hoists, conveyor systems, and the like. The descriptions herein of implementation aboard the vehicle 11 of FIG. 1 is therefore non-limiting and illustrative of just one possible implementation.

For embodiments in which the battery electric system 10 of FIG. 1 is part of the vehicle 11, the battery pack 12 may be optionally configured as a lithium-ion traction battery pack 12 having a voltage capability of, e.g., about 300 volts (V) or more. Such representative voltage levels are suitable for generating motive torque for vehicular propulsion functions and for powering various high-voltage accessories aboard the vehicle 11. In the exemplary embodiment of FIG. 1, the battery pack 12 is selectively connected to and disconnected from a load by a set of high-voltage contactors 22 arranged on a high-voltage direct current (DC) bus 23. As appreciated in the art, while laboratory-based current and voltage sensing circuits are precisely constructed such that very little current is introduced into the hardware of the sensing circuit, the mass production of the sense circuits 15 for widescale vehicle fleet integration may result in construction of the sense circuit 15 with a relatively high impedance and a resulting large current draw in comparison to laboratory variations. The compensation circuit 14 is therefore provided and controlled in accordance with the method 100 of FIG. 4 to minimize undesirable effects of the internal impedance presented by the sense circuit 15.

The load in the non-limiting configuration of FIG. 1 includes a DC link capacitor (CL) and a power inverter module (“inverter”) circuit 24. The inverter circuit 24 is connected to the battery pack 12 and the electric traction motor 26 and configured to invert a DC waveform from the battery pack 12 into an alternating current (AC) waveform suitable for energizing the electric traction motor 26. The inverter circuit 24 includes a plurality of semiconductor power switches 25 connected to phase windings of an electric traction motor (“M”) 26. As appreciated in the art, inverters such as the inverter circuit 24 shown in FIG. 1 utilize multiple dies of the semiconductor power switches 25 as fast-responding ON/OFF switching devices, e.g., insulated gate bipolar transistors (“IGBTs”), metal oxide semiconductor field-effect transistors (“MOSFETs”), thyristors, etc. In a typical three-phase configuration of the electric traction motor, the semiconductor switches are turned ON or OFF at predetermined switching intervals to output the AC waveform to phase windings of the electric traction motor 26.

The electric traction motor 26 illustrated in FIG. 1 may be connected to a rotatable output member 28, such as a motor shaft and connected gears (not shown). During a drive mode, the inverter circuit 24 is controlled with pulse width modulation or another application-suitable switching control technique to energize phase windings of the electric traction motor 26. In the depicted embodiment, the electric traction motor 26 is constructed as a polyphase AC propulsion motor, for instance a three-phase rotary electric machine. Rotation of the output member 28 ultimately transfers drive torque (To) to a coupled load, which includes a set of one or more road wheels 20 connected to the vehicle body 16 in the non-limiting embodiment of FIG. 1.

The battery electric system 10 may also include additional components for powering various systems or functions aboard the vehicle 11. For example, the battery pack 12 may be connected to an accessory power module (“APM”) 30 in the form of a DC-DC converter. The APM 30 may be operable for reducing a level of a DC voltage of the DC bus 23, e.g., about 300V or more as noted above, to a nominal 12-15V auxiliary voltage level. An auxiliary battery (“BACX”) 32 such as a 12V lead-acid battery may be electrically connected to the APM 30 on a low-voltage DC bus 230, with internal switching operation of the APM 30 ensuring that the auxiliary battery remains charged, i.e., that the auxiliary battery voltage (VAUX) equals about 12-15V.

Still referring to FIG. 1, as part of the contemplated battery electric system 10, the battery controller 50 is programmed to monitor, charge, and discharge the battery pack 12. Additionally, the battery controller 50 is programmed to execute instructions embodying the method 100 of FIG. 4 using the compensation circuit 14 to minimize undesirable effects of the high internal impedance of the reference electrode 40R (FIGS. 2 and 2A) on overall measurement accuracy. To that end, the battery controller 50 includes one or more processors 52 and a non-transitory computer-readable storage medium, i.e., memory 54. Instructions embodying the method 100 may be stored in the memory 54, with the memory 54 including various memory chips or memory circuits, e.g., magnetic or optical media, CD-ROM, solid-state/semiconductor memory (e.g., various types of RAM or ROM), etc.

Each processor 52 may be constructed from various combinations of Application Specific Integrated Circuit(s) (ASICs), Field-Programmable Gate Arrays (FPGAs), electronic circuits, central processing units, e.g., microprocessors. Non-transitory components of the memory 54 are capable of storing machine-readable instructions in the form of one or more software or firmware programs or routines, combinational logic circuit(s), input/output circuit(s) and devices, signal conditioning and buffer circuitry and other components that can be accessed by one or more processors 52 to provide a described high-voltage discharge functionality. Input/output circuits and devices for use with the battery controller 50 may include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables.

In general, the battery controller 50 of FIG. 1 is configured to receive input signals (CC_{I}) during its operation, with the input signals (CC_{I}) including the above-noted measured voltage(s) (V_{M}) and other possible values such as battery temperature. The sense circuit 15 is configured to measure cell level, pack level, or other battery voltages as the measured voltage(s) (V_{M}) to aid the battery controller 50 in performing one or more battery management actions, for instance estimating a state of charge (SOC), a state of health (SOH), and/or other possible parameters of the battery pack 12 or its constituent battery cells 120. The battery controller 50 may also selectively adjust a charging or discharging parameter of the battery pack 12 based on the derived SOC or other parameters. As part of a discharge control strategy informed by the SOC, for example, the battery controller 50 may respond by transmitting electronic control signals (CC₁₀) to components of the battery electric system 10, for instance to the MC circuit 34, the inverter circuit 24 and its various semiconductor power switches 25, as well as heating or cooling commands to a resident battery thermal management system (not shown), etc.

Referring again to FIG. 2, the MC circuit 34 is illustrated in accordance with an exemplary embodiment for use when determining the reference voltage (V_{REF}) between the reference electrode 40R and the working electrode 40E. The MC circuit 34 ultimately uses the reference voltage (V_{REF}) to determine the measured voltage (V_{M}) as noted above. Operation of the compensation circuit 14 is described below, particularly with respect to control of its first switch (S1) 47 and second switch (S2) 48. The sense circuit 15 shown in FIG. 2 is representative of just one possible hardware implementation suitable for performing the present voltage measurements, with other possible embodiments of the sense circuit 15 being usable within the scope of the disclosure. As illustrated, the representative sense circuit 15 may include a differential amplifier/buffer amplifier 41, a non-limiting example of which is shown in more detail in FIG. 2A, a comparator switch (S0) 49 connected to the buffer amplifier 41, and a comparator array 150 connected to an output side of the buffer amplifier 41 via the comparator switch 49. Thus, the comparator switch 49 may be selectively closed by a corresponding switching command from the battery controller 50 to connect the buffer amplifier 41 to the comparator array 150. A capacitor (C₂) 44 may be connected to ground between the comparator switch 49 and the comparator array 150 in an analog-to-digital converter-based implementation of the sense circuit 15, which may be used to output the digital voltage signal (V_{DC}) to the processor 52 of the battery controller 50.

With respect to the compensation circuit 14 in particular, the first switch 47 is positioned between a voltage source (Vs) 43, e.g., a low-voltage cell battery, and the sense circuit 15. As part of the present strategy disclosed below, the voltage provided by the voltage source 43, i.e., a source voltage, is set to equal to a measured voltage (V_{M}) at a previous time step, so that an isolation capacitor (C₁) 42 is charged to a threshold voltage that is as close to the present measured voltage (V_{M}) as possible. The first switch 47 is configured to close and open to respectively connect and disconnect the voltage source 43 when charging the isolation capacitor 42 to this threshold voltage. The working electrode 40E whose voltage level is being measured is connected to the sense circuit 15, in this case to an input side of the buffer amplifier 41. The voltage source 43 therefore may be connected to/disconnected by operation of the first switch 47.

The second switch 48 of the compensation circuit 14 is connected between the compensation circuit 14 and the sense circuit 15 and configured to close, which occurs out-of-phase with the first switch 47 (see FIG. 3). Closing of the second switch 48 connects the reference electrode 40R and the compensation circuit 14 to the sense circuit 15. This action may be performed in response to a second switching control signal to the second switch 48, with the noted first and second switching control signals to the respective first and second switches 47 and 48 being part of the aforementioned control signals (CC₁₀).

The reference electrode 40R as contemplated herein has a high characteristic impedance (R_{INT}), which in turn is represented as a resistor 46 in the equivalent circuit diagram of FIG. 2. In addition to the voltage source 43, the compensation circuit 14 also includes the isolation capacitor 42, which in turn is connected in parallel with the sense circuit 15. Another resistor 45 is shown in series with the voltage source 43 to represent an internal resistance (R_{S}) thereof.

Referring to FIG. 2A, the buffer amplifier 41 is shown in greater detail to illustrate parasitic voltages and currents that may be present to do the high impedance of the reference electrode 40R. While the construction of the sense circuit 15 may vary with the application, the impedance presented by the reference electrode 40R due to polarization or other factors may result in such parasitic elements. The parasitic elements, in the absence of the present teachings, may produce a large voltage drop across the sense circuit 15, thus reducing measurement accuracy. In FIG. 2A, the parasitic elements are represented as an input resistance (R_{IN}) 61 and a biasing current (I_{B}) 63 within the buffer amplifier 41. Other sense circuits 15 may be used in other embodiments, including those lacking the buffer amplifier 41, and therefore the illustrated construction of FIG. 2A is intended to be illustrative of the present teachings and nonlimiting.

Regardless of the structure of the sense circuit 15, the reference electrode 40R does not act as an Ohmic resistance. Rather, the reference electrode 40R acts as a complex impedance element. Therefore, the reference voltage (V_{REF}) between the reference electrode 40R and the working electrode 40E for a given voltage measurement by the sensing circuit 15 may vary from the measured voltage (V_{M}). The battery controller 50, which is in communication the respective first and second switches 47 and 48, is operable to compensate for the negative effects of such parasitic elements by controlling the first and second switches 47 and 48. This occurs by commanding respective duty cycles via the electronic control signals (CC₁₀) of FIG. 1 to thereby measure the cell voltage as the measured voltage (V_{M}). The battery controller 50 thereafter uses the digital voltage signal (V_{DC}) to perform one or more battery management actions as noted above.

FIG. 3 illustrates a pulse train 65 of exemplary duty cycles for controlling a corresponding open/closed state of the respective first and second switches 47 and 48 of the compensation circuit 14 of FIG. 2. The open/closed state is illustrated on the vertical axis, with a nominal binary state of “1” corresponding to a closed switch and a nominal binary state of “0” corresponding to an open state. Time in milliseconds (ms) is shown on the horizontal axis. The first switch 47 and the second switch 48 of FIG. 2 have a corresponding closed/conducting duration (SS1, SS2) during which the first and second switches 47 and 48 are both closed. At a calibrated time (t_{cal}), the first switch 47 is commanded to close, with the first switch 47 thereafter remaining in a closed state (SS1) until a predetermined time (t₁). The first switch 47 opens at t₁, with the respective first and second switches 47 and 48 remaining open for a predetermined duration. The second switch 48 is then commanded to transition to a closed state (SS2). The closed state (SS2) is sustained until time t₃.

As shown in FIG. 3, the closed state (SS2) of the second switch 48 is a fraction of a duration of the closed state (SS1) of the first switch 47, i.e., SS1>SS2. Closure of the first switch 47 of FIG. 2 for this relatively long duration ensures proper charging of the isolation capacitor 42 by the voltage source 43. As noted above, charging of the isolation capacitor 42 by the voltage source 43 continues to a threshold voltage that is as close to the present measured voltage (V_{M}). A duration of the closed state (SS2) may be less than half of the duration (SS1) in one or more embodiments.

In some implementations, the battery controller 50 may be programmed to follow the digital signal voltage (V_{DC}) of FIGS. 1 and 2 at a previous time step, such as an immediately prior point in time at which the digital signal voltage (V_{DC}) was measured. Doing so may help reduce a parasitic current drawn from the reference electrode 40R. To this end, the battery controller 50 may be programmed to control a closing and opening sequence of the first switch 47 and the second switch 48 so that the digital signal voltage (V_{DC}) matches the reference voltage (V_{REF}) across the reference electrode 40R at a previous time step when recharging the isolation capacitor 42.

Referring now to FIG. 4, an embodiment of the method 100 may be used with the MC circuit 34 of FIGS. 1 and 2 to compensate for parasitic elements in the battery electric system 10. The method 100 is described in terms of discrete logic blocks for simplicity, and may be performed by the battery controller 50 of FIG. 1 during operation of the vehicle 11. As appreciated in the art, laboratory-based current and voltage sensing circuits are often precisely constructed such that very little electric current is introduced into the sense circuit 15. However, the nature of mass production and host system integration, for example across a fleet of the vehicles 11 of FIG. 1, may result in the need for constructions of the sense circuit 15 having a relatively large current draw. In such a case, the compensation circuit 14 of FIG. 2 may be controlled in accordance with the method 100 to minimize undesirable effects of internal impedance of the reference electrode 40R.

The method 100 begins with block B101 (“Start”). The battery electric system 10 may be in a particular state when the method 100 commences, e.g., the vehicle 11 may be parked, or it may be in a drive mode or charging mode. Block B101 in such a case may entail initiating a key-on event of the vehicle 11, or performing another action that results in a need to detect the measured voltage (V_{M}) and the reference voltage (V_{REF}) of FIGS. 2 and 2A. The method 100 proceeds to block B102 once the method 100 has initiated.

Block B102 includes setting the respective first and second switches 47 and 48 of FIG. 2 to an open state, i.e., S1=0 and S2=0 in the representative pulse train 65 of FIG. 3. This switching control action may be commanded by the battery controller 50, for instance via a wired or wireless first and second switching control signals to the first and second switches 47 and 48 as part of the electronic control signals (CC₁₀) illustrated in FIG. 1, or corresponding control circuitry thereof. The method 100 thereafter proceeds to block B103.

At block B103, the battery controller 50 starts a timer and determines, based on the current value of the timer, whether the total elapsed time (t) determined by the counter is equal to a calibrated time (t_{CAL}), for example as illustrated in FIG. 3. The method 100 includes repeating block B103 in a loop until t=t_{CAL}, with the method 100 thereafter proceeding to block B104.

At block B104, which is reached when the elapsed time (t) is equal to the calibrated time (t_{CAL}), the battery controller 50 commands the first switch 47 of FIG. 2 to close, i.e., S1=1, with “1” in this instance corresponding to the nominal binary state of 1 that indicates the closed state (SS1) in FIG. 3. This action connects the voltage source 43 to the isolation capacitor 42 to commence charging of the isolation capacitor 42. The method 100 thereafter proceeds to block B105.

Continuing with the discussion of FIG. 4, block B105 includes determining via the battery controller 50, e.g., using the above-noted timer, whether the elapsed time (t) is equal to a predetermined first time duration (t₁), which once again is illustrated in FIG. 3. The method 100 includes repeating blocks B104 and B105 in a loop until t=t_{CAL}, with the method 100 thereafter proceeding to block B106.

Block B106 of the method 100 includes commanding the first switch 47 of FIG. 2 to open again, i.e., S1=0. As with the above-described switching control actions, block B106 may be implemented by the battery controller 50, e.g., via a voltage signal or pulse width modulation signal depending on the construction of the first switch 47. The method 100 thereafter proceeds to block B107.

Block B107 includes determining via the battery controller 50 whether the elapsed time (t) is equal to a predetermined second time duration (t₂), for example as shown in FIG. 3. The method 100 includes repeating blocks B106 and B107 in a loop until t=t₂, with the method 100 thereafter proceeding to block B108.

At block B108, the battery controller 50 commands the second switch (S2) to close, i.e., S2=1, in a step analogous to block B104. The second switch thus enters the closed state (SS2) of FIG. 3, which occurs after the first switch 47 has opened. The method 100 thereafter proceeds to block B109.

Block B109 entails determining via the battery controller 50 of FIG. 1 whether the elapsed time (t) is equal to a predetermined third time duration (t₃), with this representative time likewise shown in FIG. 3. The method 100 includes repeating blocks B108 and B109 in a loop until t=t₃, with the method 100 thereafter proceeding to block B110.

Block B110 of FIG. 3 includes commanding the second switch 48 of FIG. 2 to open, i.e., S2=0. The method 100 thereafter proceeds to block B111.

Block B111 (“End”) represents completion of one cycle of the pulse train 65 of FIG. 3. The method 100 may continue in a loop by starting anew at block B102 so long as the battery electric system 10 of FIG. 1 remains running, or as long as voltage measurements are required by the battery controller 50.

The method 100 of FIG. 4 is thus usable with the battery electric system 10 of FIG. 1 or another host system having one of more of the battery cells 120. In general, embodiments of the method 100 include closing the first switch 47 via the battery controller 50 to connect the voltage source 43 to the isolation capacitor 42 of FIG. 2. The method 100 includes charging the isolation capacitor 42 using the voltage source 43, thereafter opening the first switch 47 via the battery controller 50. The battery controller 50 then closes the second switch 48 of FIG. 2 after opening the first switch 47 to thereby connect the compensation circuit 14 to the sense circuit 15.

At this point, the method 100 proceeds by measuring a cell voltage of the battery cell 120 via the sense circuit 15 and thereafter outputting the digital voltage signal (V_{DC}) to the battery controller 50. This action occurs via the sense circuit 15, with the digital voltage signal (V_{DC}) being indicative of the measured cell voltage, i.e., V_{M}, as noted above. The method 100 may also encompass performing a battery management action of the battery cell 120 via the battery controller 50 in response to the digital voltage signal (V_{DC}), for example by estimating the SOC of the battery cell 120 and thereafter adjusting a charging or discharging parameter based on the estimated SOC.

Controlling the closing and opening sequence of the first and second switches 47 and 48 via the battery controller 50 in one or more embodiments may include matching the reference voltage (V_{REF}) across the reference electrode 40R of FIGS. 2 and 2A at a previous time step when charging the isolation capacitor 42. As noted above, this entails setting the voltage provided by the voltage source 43 equal to the measured voltage (V_{M}) at a previous time step, so that the isolation capacitor 42 is charged to a threshold voltage that is as close to the present measured voltage (V_{M}) as possible.

In accordance with the present teachings, controlling operation of the compensation circuit 14 in accordance with the method 100 and its various alternative embodiments thus minimizes the voltage drop across the reference electrode 40R. Likewise, controlling operation of the compensation circuit 14 may occur such that a current draw of the reference electrode 40R when the sense circuit 15 is in operation is characterized by an absence of frequencies below a respective duty cycle frequency of the first and second switches 47 and 48.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features. cm What is claimed is:

1. A battery electric system comprising:
a battery cell;
a reference electrode;
a voltage sensing circuit (“sense circuit”) operable for measuring a cell voltage of the battery cell as a measured battery voltage, and for outputting a digital voltage signal that is indicative of the measured battery voltage;
a compensation circuit connectable to the sense circuit, including:
a voltage source;
an isolation capacitor that is connected in parallel with the sense circuit;
a first switch positioned between the voltage source and the sense circuit, the first switch being configured to close in response to a first switching control signal to thereby connect the voltage source to the isolation capacitor for charging of the isolation capacitor; and
a second switch that is connected between the compensation circuit and the sense circuit, and configured to close out-of-phase with the first switch in response to a second switching control signal, wherein closing the second switch connects the reference electrode and the compensation circuit to the sense circuit; and
a battery controller in communication with the first switch and the second switch, the battery controller being operable to output the first switching control signal and the second switching control signal to control respective duty cycles of the first switch and the second switch to thereby measure the cell voltage via the reference electrode and the sense circuit, and to thereafter perform a battery management action using the digital voltage signal.

2. The battery electric system of claim 1, wherein the battery controller is programmed to control a closing and opening sequence of the first switch and the second switch to match a reference voltage between the reference electrode and a working electrode of the battery cell at a previous time step when recharging the isolation capacitor.

3. The battery electric system of claim 1, wherein the sense circuit includes an analog-to-digital converter.

4. The battery electric system of claim 3, wherein the analog-to-digital converter includes a buffer amplifier having a parasitic bias current, and wherein the battery controller is configured to control operation of the compensation circuit to minimize a voltage drop across the reference electrode due to the parasitic bias current.

5. The battery electric system of claim 1, wherein the battery controller is configured to control the operation of the compensation circuit such that a current draw of the reference electrode is characterized by an absence of frequencies below a respective duty cycle frequency of the first switch and the second switch.

6. The battery electric system of claim 1, wherein the reference electrode is a porous electrode.

7. The battery electric system of claim 1, wherein the battery controller is configured to estimate a state of charge (SOC) of the battery cell as the battery management action, and to adjust a charging or discharging parameter based on the SOC of the battery cell.

8. The battery electric system of claim 1, wherein the battery cell is a lithium-ion or lithium metal battery cell.

9. A vehicle, comprising:
a vehicle body;
a set of road wheels connected to the vehicle body;
an electric traction motor connected to one or more of the road wheels; and
a battery pack connected to the electric traction motor, the battery pack being configured to energize the electric traction motor to power the one of more of the road wheels, the battery pack including:
a reference electrode;
a voltage sensing circuit (“sense circuit”) operable for measuring a cell voltage of a battery cell of the battery pack as a measured battery voltage, and for outputting a digital voltage signal that is indicative of the measured battery voltage;
a compensation circuit connectable to the voltage sensing circuit, including:
a voltage source;
an isolation capacitor that is connected in parallel with the sense circuit;
a first switch positioned between the voltage source and the isolation capacitor, the first switch being configured to close in response to a first switching control signal to thereby connect the voltage source to the isolation capacitor; and
a second switch that is connected between the compensation circuit and the sense circuit, and configured to close out-of-phase with the first switch in response to a second switching control signal, wherein closing the second switch connects the reference electrode and the compensation circuit to the sense circuit; and
a battery controller in communication with the first switch and the second switch, the battery controller being operable to output the first switching control signal and the second switching control signal to control respective duty cycles thereof, measure the cell voltage via the reference electrode and sense circuit, and thereafter perform a battery management action using the digital voltage signal.

10. The vehicle of claim 9, further comprising:
an inverter circuit having a plurality of semiconductor switches, wherein the inverter circuit is connected to the battery pack and the electric traction motor and configured to invert a direct current waveform from the battery pack into an alternating current waveform for powering the electric traction motor.

11. The vehicle of claim 9, wherein the battery controller is programmed to control a closing and opening sequence of the first switch and the second switch to thereby match a reference voltage between the reference electrode and a working electrode of the battery cell at a previous time step when charging the isolation capacitor.

12. The vehicle of claim 9, wherein the sense circuit includes an analog-to-digital converter having a buffer amplifier, the buffer amplifier having a parasitic bias current, and wherein the battery controller is configured to control operation of the compensation circuit to minimize a voltage drop across the reference electrode due to the parasitic bias current.

13. The vehicle of claim 9, wherein the battery controller is configured to control the operation of the compensation circuit such that a current draw of the reference electrode is characterized by an absence of frequencies below a respective duty cycle frequency of the first switch and the second switch.

14. The vehicle of claim 9, wherein the battery controller is configured to estimate a state of charge (SOC) of the battery cell as the battery management action, and to adjust a charging or discharging parameter based on the SOC of the battery cell.

15. The vehicle of claim 9, wherein the battery pack includes a plurality of lithium-ion or lithium metal battery cells, and wherein the reference electrode is a porous electrode.

16. A method for use with a battery electric system having a battery cell, the method comprising:
closing a first switch, via a battery controller, to connect a voltage source of a compensation circuit to an isolation capacitor, the isolation capacitor being connected in parallel with a voltage sensing circuit;
charging the isolation capacitor using the voltage source;
opening the first switch, via the battery controller, after charging the isolation capacitor;
closing a second switch, via the battery controller, after opening the first switch to thereby connect a reference electrode and the compensation circuit to a voltage sensing circuit (“sense circuit”);
measuring a cell voltage of the battery cell using the reference electrode, via the sense circuit;
outputting a digital voltage signal to the battery controller via the sense circuit, the digital voltage signal being indicative of the cell voltage; and
performing a battery management action of the battery cell via the battery controller in response to the digital voltage signal.

17. The method of claim 16, further comprising:
controlling a closing and opening sequence of the first switch and the second switch via the battery controller so as to match a reference voltage between the reference electrode and a working electrode of the battery cell at a previous time step when charging the isolation capacitor.

18. The method of claim 16, wherein the sense circuit includes an analog-to-digital converter having a buffer amplifier, the buffer amplifier having a parasitic bias current, further comprising:
controlling operation of the compensation circuit to minimize a voltage drop across the reference electrode due to the parasitic bias current.

19. The method of claim 16, further comprising:
controlling an operation of the compensation circuit such that a current draw of the reference electrode is characterized by an absence of frequencies below a respective duty cycle frequency of the first switch and the second switch.

20. The method of claim 16, wherein performing the battery management action of the battery cell includes estimating a state of charge (SOC) of the battery cell, and thereafter adjusting a charging or discharging parameter based on the SOC of the battery cell.
